(19) United States
(12) Patent Application Publication
(10) Pub. No.: US 2022/0391791 A1
(43) Pub. Date: Dec. 8, 2022

(54) SYSTEM AND METHOD FOR MODIFICATION OF FUTURE RECIPIENTS IN AN ELECTRONIC SIGNATURE WORKFLOW

(71) Applicant: Certinal Software Private Limited, Mumbai (IN)

(72) Inventors: Kanishka Ghosh, Mumbai (IN); Krishnendu Chattopadhyaya, Mumbai (IN)

(73) Assignee: Certinal Software Private Limited, Mumbai (IN)

(21) Appl. No.: 17/682,790

(22) Filed: Feb. 28, 2022

(30) Foreign Application Priority Data
Mar. 25, 2021 (IN) 202121013064

(51) Int. Cl. G06Q 10/06; G06Q 50/18; G06F 40/166; G06F 40/197

(52) U.S. Cl. CPC G06Q 10/0633; G06Q 50/18; G06F 40/166; G06F 40/197

(57) ABSTRACT

A system (1) and method for modification of future recipients in an electronic signing workflow, including an electronic document (2), a pre-defined signing workflow (11), a sender (3), plurality of recipients (4) including a current recipient and at least one future recipient, a sender communication device (5), a receiver communication device (6), a communication interface, a processing unit, set of computer readable instructions and a computer readable storage medium, wherein the system and method facilitates the modification of at least one future recipient by the sender (3) or any recipient (4) in the workflow (11), once the document (2) has been sent by the sender for signing, and wherein the system is adapted to send the document (2) to the updated recipient, alert the updated recipient, present him with inconsistent signature tags, accept his instructions, and rectify the signature tags.

### CROSS-REFERENCE TO RELATED APPLICATION

The instant application claims priority to Indian Patent Application Serial No. 202121013064, filed Mar. 25, 2021, pending, the entire specification of which is expressly incorporated herein by reference.

### FIELD OF THE INVENTION

The present invention relates to electronic signing of electronic documents. Particularly, the present invention relates to a system and a method for modification of future recipients in an electronic signing workflow of an electronic document, both by the document sender as well as the document recipients involved in the workflow.

### BACKGROUND OF THE INVENTION

Electronic documents form an integral part of today's business world. In a business scenario, these electronic documents can be crucial documents such as agreements, contracts, tax documents, legal documents to name a few. Such documents typically require a number of people to sign them in order to be validated.

Traditionally, such important business documents were shared and exchanged between all the signatories involved in the document in order for them to sign the documents physically. This made the document exchange and signing a very cumbersome and time consuming process. In order to overcome this problem, the concept of electronic signatures was introduced a few years back. Electronic signatures make the electronic document signing process very user friendly, secure, convenient, easily accessible and less time consuming.

A few electronic signature platforms have emerged in the past few years which facilitate the process of electronic signing of the electronic documents. However, these platforms have their own limitations. For instance, in most of the electronic signature platforms currently available in the market, once the sender of the document specifies the recipients and sends the concerned electronic document to these recipients for signature, the sender is not able to modify any of the recipients, i.e., no modifications in the recipients can be made when the document to be signed is on the fly.

U.S. Pat. No. 9,942,396 describes workflows that enable documents to be distributed, assented to, and otherwise interacted with on an aural and/or oral basis. Such workflows can be implemented so as to allow a recipient to receive, understand, and interact with a document using conventional components such as the microphone and speaker provided by a telephone. The recipient can listen to the audio version of the document terms and record an electronic signature that represents assent to such terms. An electronic signature server can record the recipient's electronic signature and incorporate it into the document, such that it forms part of the electronic document just as a traditional handwritten signature forms part of a signed paper document.

U.S. Pat. No. 8,868,916 describes techniques for providing a self-contained electronic signature. In some embodiments, techniques for providing a self-contained electronic signature include recording an audit trail for a plurality of events associated with an electronic signature of an electronic document; embedding the audit trail in the electronic document; and digitally signing the electronic document, in which the electronic document including the embedded audit trail and the electronic signature are secured by the digital signature. In some embodiments, the audit trail is embedded in metadata of the electronic document, a body of the electronic document, or both the metadata and body of the electronic document. In some embodiments, digitally signing the electronic document includes a certifying signature provided by a service provider of an electronic signature service.

A very few of the available electronic signature platforms have the provision of delegation. The delegation feature allows the sender or recipient in the workflow to delegate the current recipient to a new recipient. For example, if X is the sender of the document to be signed and A, B, C, D, E, F are the recipients defined in the signing workflow, with the signing order being A—B—C—D—E—F, any recipient say recipient A can only delegate the signing task to another recipient and cannot modify a recipient per se.

However, there may arise different business scenarios wherein a future recipient in the workflow needs to be modified. For instance, considering the same example as stated above, say when the document is pending with recipient A for signing, no other future recipient can be modified by the sender and/or the recipients defined in the workflow. In a scenario wherein the recipient C is on leave and the recipient A is aware of it, A would ideally like to change the recipient to a new recipient, say Z. Such kind of a modification of future recipient can also be intended by the sender, for yet another valid reason. This modification is intended so as to avoid slowing down of the signing task. However, the current platforms available do not have any provision for modification of future recipients in the defined signing workflow, either by the sender of the document or the recipients defined in the workflow.

The above technical problem has been solved by the present invention.

### OBJECTS OF THE INVENTION

An object of the present invention is to provide a system and method for electronic signing of electronic documents.

Another object of the present invention is to provide a system and method which enables the modification of future recipients defined in an electronic signing workflow.

Yet another object of the present invention is to provide a system and method which allows both the sender of the electronic document as well as the recipients defined in a electronic signing workflow, to modify future recipients defined in that workflow.

Yet another object of the present invention is to provide a system and method for electronic signing of electronic documents, wherein the approval rights remain with the original sender in an event whereby a recipient modification request is made by another recipient defined in the signing workflow.

Yet another object of the present invention is to provide a system and method which identifies the discrepancies between the signature tags on the document whenever a recipient modification request is approved by the sender, presents the new recipient with the locations of these signature tags and replaces the earlier signature tags with the updated signature tags.

Yet another object of the present invention is to provide a system and method which allows modification of recipients in a defined electronic signing workflow, after the document has been sent out for signing by the sender, i.e., when the document is on the fly in the defined workflow.

Yet another object of the present invention is to provide a system and method which provides greater flexibility in terms of modification of recipients in a defined workflow, thereby reducing the overall time required for completing the document signing process by all the recipients, consequently easing up various kinds of business processes.

### SUMMARY OF THE INVENTION

The present invention relates to a system and method for modification of future recipients in an electronic signing workflow of an electronic document.

In one aspect, the system and method of the present invention allows the sender of the document to modify a future recipient in the signing workflow, once the document has been sent by the sender. The sender can essentially modify one or more future recipients who are yet to sign the document, at any given point in the workflow, when the document is on the fly. This future recipient modification can be done by the sender even when the document is pending with a current recipient and hasn't even reached the concerned future recipient for signing.

In another aspect, the system and method of the present invention allows even a recipient defined in the signing workflow of the document to modify a future recipient in the signing workflow, once the document has been sent by the sender. Any recipient in a given signing workflow can essentially modify one or more future recipients, once the document has been sent by the user. This future recipient modification can be done by a recipient in the workflow even when the document is pending with a current recipient and hasn't even reached the concerned future recipient for signing.

In yet another aspect, when a future recipient modification request is made by one of the recipients in the defined workflow, the ultimate request approval right stays with the sender of the document. The given request made by a recipient in the workflow can either be approved or be objected/denied by the sender of the document. This implies that a modification request and hence the consequent modification of the future recipient cannot be executed without obtaining the approval of the sender. This provides an additional control checkpoint in the signing workflow.

In yet another aspect, when the sender approves the future recipient modification request made by a recipient in the defined in the signing workflow, the new recipient receives the document for signing. Along with the document, the new recipient also receives an alert from the system mentioning the discrepancy in the name of the signature tags associated with the modified recipient. The new recipient is also presented by the system with all the signature places and signature tags wherein he is allowed to enter the new recipient's name (rectification of name) instead of the name of the recipient who has been modified.

### BRIEF DESCRIPTION OF THE DRAWINGS

FIG. 1 illustrates the overview of the system of the present invention.

FIG. 2 illustrates an exemplary sender defined signing workflow, applicable for all the embodiments of the invention.

FIG. 3 illustrated a flowchart representing the event and steps involved wherein a future recipient is modified by the sender of the document.

FIG. 4 illustrates a flowchart representing the event and steps involved wherein a future recipient is modified by another recipient defined in the signing workflow of the document.

### DETAILED DESCRIPTION OF THE INVENTION

Before the present invention is described, it is to be understood that this invention is not limited to methodologies described, as these may vary as per the person skilled in the art. It is also to be understood that the terminology used in the description is for the purpose of describing the particular embodiments only and is not intended to limit the scope of the present invention. Throughout this specification, the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The use of the expression “at least” or “at least one” suggests the use of one or more elements or ingredients or quantities, as the use may be in the embodiment of the invention to achieve one or more of the desired objects or results. Various embodiments of the present invention are described below. It is, however noted that the present invention is not limited to these embodiments, but rather the intention is that modifications those are apparent are also included.

Throughout the description of the present invention, the following is to be taken into consideration:

“Document” refers to an electronic document.

“Sender” refers to the person who is the originator of the document, i.e., the person who sends the document to be electronically signed to all the recipients, defines the signing workflow and also defines the particular sequence of the recipients in which they are required to sign the document.

“Recipient” refers to any person in the signing workflow, other than the sender, who is designated to provide an electronic signature on the document sent by the sender.

“Current recipient” refers to any recipient with whom the document is, at any instantaneous point in the signing workflow defined by the sender.

“Future recipient(s)” refers to any recipient(s) listed downstream of the current recipient in the sender defined sequence of the signing workflow.

“Signature tags” refer to any signature boxes or signature spaces which are present in any electronic document, wherein the parties' names, designation or dates are mentioned. It is the place for signing in the electronic document.

The term “modify” used in the specification in context of the recipient modification, may involve a multitude of actions such as addition, deletion, replacement or provision of an alternate recipient.

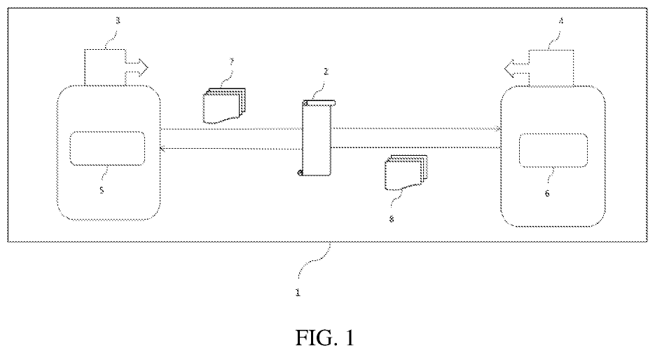

Referring to FIG. 1, the system (1) of the invention comprises of an electronic document, hereinafter referred to as just the “document” (2) to be signed, a sender (3) of the document (2), multiple recipients (4) of the document (2), a sender communication device (5), a recipient communication device (6), a communication interface (7) at the sender's end, a communication interface (8) at the recipient's end, a set of computer readable instructions (9), (10) which can be provided by the sender (3) and the recipient (4) respectively by means of the communication interfaces.

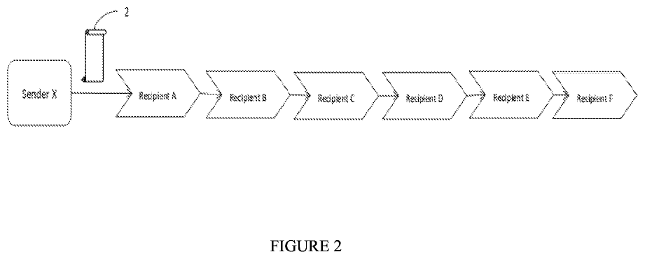

In addition to this, the system (1) also comprises of a sender defined workflow (11) as depicted in FIG. 2, for the execution of signing task of the document (2). Further, the system (1) of the invention also comprises of a processing unit operably associated with the each of the communication devices (5) and (6) and is adapted to execute the instructions (9) and (10) provided by the sender (3) and the recipient (4) respectively. Furthermore, the system (1) also includes a computer readable memory storage medium capable of storing the instructions (9) and (10) provided by the sender (3) and the recipient (4) respectively.

In all the preferred embodiments of the invention described below, the entire workflow of the electronic signing process involves the initial step of the sender sending the document to be electronically signed to a plurality of recipients wherein the sender specifies the list of recipients and the sequence in which they are required to sign the document. For better understanding of the actual workflow, consider the following exemplary workflow for explanatory purposes and refer to FIG. 2 of the drawings:

X=Sender

Recipients=A, B, C, D, E, F

Sequence in which the recipients are required to sign the document=A—B—C—D—E—F

It is to be noted that this is only an example and that in the actual scenario, the number of recipients can be smaller or greater than the one specified herein. Nevertheless, the same example shall be used throughout the description hereafter to describe all the embodiments of the invention.

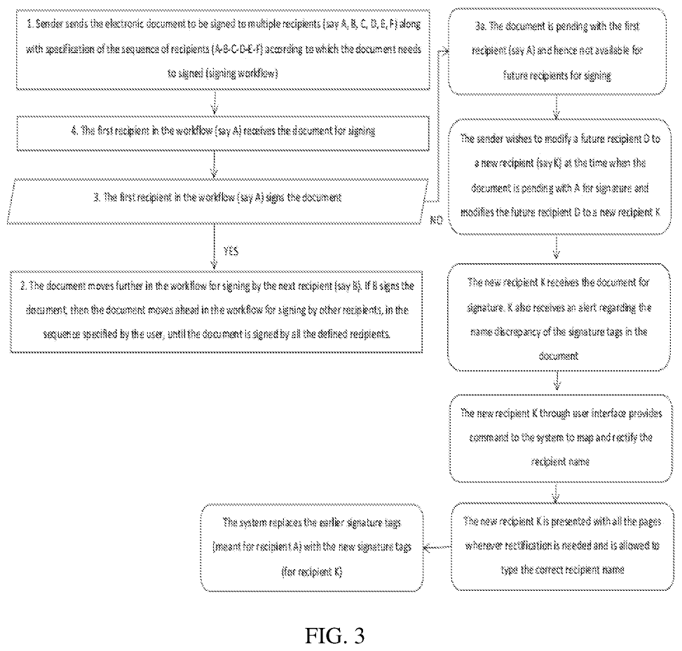

Referring to FIG. 3, once the sender sends the document to be signed, the document is received by the first recipient A in the defined workflow. At this stage, recipient A becomes the current recipient in the workflow. Two events may occur at this stage of the workflow. Either the current recipient A can sign the document or he/she cannot do so immediately, due to whatsoever reasons, which in turn would keep the document pending with A.

In an event wherein the current recipient A signs the document, the signature by current recipient A is registered in the document and the document moves ahead in the signing workflow to the next recipient, i.e., recipient B. In this case, when recipient B receives the document for signing, B becomes the current recipient in the workflow. The current recipient changes throughout the process, depending on which recipient has the access to the document for signing at a given moment.

As stated above, in an event wherein the current recipient A does not sign the document, the document stays at hold with current recipient A. This slows down the signing process as the future recipients B, C, D, E, F do not have access for signing the document unless the current recipient A signs the document. In such a case, the system and method of the present invention, allows the sender to modify any future recipient in the workflow (B, C, D, E, F) even when the document is pending with the current recipient A for signing. In an event wherein the sender X intends to modify any one or more of the future recipients, the sender directly can modify a future recipient, regardless of the fact that the document is pending with A for his or her signature.

Consider an event wherein the sender X modifies one of the future recipients D to a new recipient K, when the document is pending with the current recipient A for signing. Once the sender X assigns K as the signatory instead of D, the new recipient K receives the document for signing. Along with receiving the document for signing, the new recipient K also receives an alert from the system regarding the discrepancy in the signature tags of the document. Here, as D is the initially defined recipient, the document comprises of signature tags associated with recipient D's name. However, when the recipient is modified from D to K, the signature tags also need to be rectified in the document so as to make them consistent with the new recipient (signatory) K's name.

The system of the present invention allows the new recipient K to provide command by means of a graphical user interface of his or her device, to map and rectify the earlier recipient name (D) associated signature tags in the document. The system maps and presents to the new recipient K, all the relevant signature pages by means of a graphical user interface wherein signature tags with earlier recipient D's name are present. At the same time, the system also allows the new recipient K to provide the new recipient name. Once the new recipient K provides the new recipient name, the system replaces all the signature tags in the document with earlier recipient's (D's) name with the new recipient's (K's) name. This auto mapping, presenting and rectifying feature of the system of the present invention makes sure that any changes made by the sender X in terms of recipient modification are synchronized well with the document content updating, wherever applicable and necessary.

In another preferred embodiment of the present invention, the recipients defined in the signing workflow can also change a future recipient in the workflow. In conventional electronic document signing management systems, the recipient modification authority is usually restricted to the sender of the document.

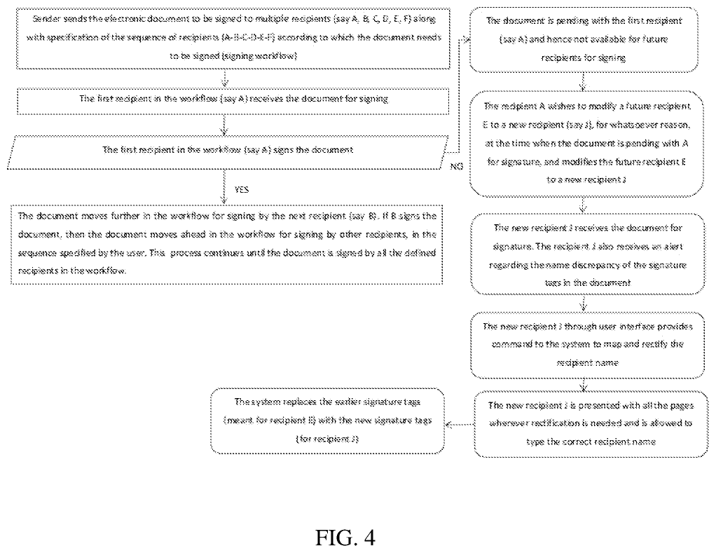

Referring to FIG. 4, consider an event similar to an event described before, wherein the sender sends the document for signing and is pending with a current recipient A in the workflow. In this embodiment of the invention, any recipient in the workflow (A/B/C/D/E/F) can modify one or more future recipients defined in the workflow. For example, recipient A can modify any of the future recipients B, C, D, E, F. B can modify any future recipient C, D, E, F. C can modify any future recipient D, E, F; and so on and so forth.

When one future recipient, say E, is modified to a new recipient, say J, by another recipient in the workflow, say A when the document is with the recipient A, an alert is sent to the sender X of the document for the proposed modification approval. Such kind of a modification request by a recipient in the workflow can be triggered for any reason e.g. If the sender X is unaware of the fact that the recipient E is on leave in the organization, and if the recipient A is well aware of it, the recipient A can trigger a modification request to change the signatory from E to J.

If the sender X approves the modification request sent by recipient A, the system sends the document to the new recipient J for signing. Along with receiving the document for signing, the new recipient J also receives an alert from the system regarding the discrepancy in the signature tags of the document. A similar process as described before, of mapping, presenting and rectification of signature tags is followed by the system to synchronize the modification of the recipient E to J with the updating of corresponding signature tags in the name of the new recipient J. This feature of the present invention enables the recipients in the workflow to have a modification right similar to that of the sender of the document. However, it is to be noted that the approval and execution rights with respect to recipient modification are with the sender X and not with any of the recipients. Recipients can only trigger a modification request, but the execution of the requested modification can only happen with the sender's approval. This feature provides an additional control checkpoint in the signing workflow. On the other hand, the sender X can also raise an objection against and/or deny such a modification request made by recipient A.

It is important to note that in any of the embodiments described above, the sender and/or the recipients cannot modify a previous recipient who has already completed his or her action, i.e., signed the document. All the embodiments described in this specification allow the modification of either the current recipient or a future recipient in the defined workflow, and not a previous recipient per se.

In some applications, the present invention described above may be provided as elements of an integrated software system, in which the features may be provided as separate elements of a computer program. Some embodiments may be implemented, for example, using a computer-readable storage medium (e.g., non-transitory) or article which may store an instruction or a set of instructions that, if executed by a processor, may cause the processor to perform a method in accordance with the embodiments. Other applications of the present invention may be embodied as a hybrid system of dedicated hardware and software components. Moreover, not all of the features described above need be provided or need be provided as separate units. Additionally, it is noted that the arrangement of the features do not necessarily imply a particular order or sequence of events, nor are they intended to exclude other possibilities. For example, the features may occur in any order or substantially simultaneously with each other. Such implementation details are immaterial to the operation of the present invention unless otherwise noted above.

The exemplary methods and computer program instructions may be embodied on a computer readable storage medium (e.g., non-transitory) that may include any medium that can store information. Examples of a computer readable storage medium (e.g., non-transitory) include electronic circuits, semiconductor memory devices, ROM, flash memory, erasable ROM (EROM), floppy diskette, CD-ROM, optical disk, hard disk, fiber optic medium, or any electromagnetic or optical storage device. In addition, a server or database server may include computer readable media configured to store executable program instructions. The features of the embodiments of the present invention may be implemented in hardware, software, firmware, or a combination thereof and utilized in systems, subsystems, components or subcomponents thereof.

Furthermore, a software program embodying the features of the present invention may be used in conjunction with a computer device or system. Examples of a computing device or system may include, but are not limited to, an electronic book reading device, a computer workstation, a terminal computer, a server computer, a handheld or mobile device (e.g., a tablet computer, a personal digital assistant “PDA,” a mobile telephone, a Smartphone, etc.), a web appliance, a network router, a network switch, a network bridge, any machine capable of executing a sequence of instructions that specify an action to be taken by that machine, and any combinations thereof. In one example, a computing device may include and/or be included in, a kiosk.

As used herein, the term “mobile device” is intended to encompass any form of programmable computing device as may exist, or will be developed in the future, that implements a communication module for wireless voice and data communications, including, for example, cellular telephones, personal data assistants (PDA's), palm-top computers, laptop, and notebook computers, wireless electronic mail receivers (e.g., the BLACKBERRY™ and TREO™ devices), multimedia Internet enabled cellular telephones (e.g., the BLACKBERRY STORM™, and similar personal electronic devices that include a wireless communication module, processor and memory.

The computer device or system may also include an input device. In one example, a user of the computer device or system may enter commands and/or other information into computer device or system via an input device. Examples of an input device may include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), touchscreen, and any combinations thereof. The input device may be interfaced to bus via any of a variety of interfaces including, but not limited to, a serial interface, a parallel interface, a game port, a USB interface, a FIREWIRE interface, a direct interface to bus, and any combinations thereof. The input device may include a touch screen interface that may be a part of or separate from the display.

A user may also input commands and/or other information to the computer device or system via a storage device (e.g., a removable disk drive, a flash drive, etc.) and/or a network interface device. A network interface device, such as network interface device may be utilized for connecting the computer device or system to one or more of a variety of networks and/or one or more remote devices connected thereto. Examples of a network interface device may include, but are not limited to, a network interface card (e.g., a mobile network interface card, a LAN card), a modem, and any combination thereof. Examples of a network may include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software, etc.) may be communicated to and/or from the computer device or system via a network interface device.

The computer device or system may further include a video display adapter for communicating a displayable image to a display device, such as a display device. Examples of a display device may include, but are not limited to, a liquid crystal display (LCD), a cathode ray tube (CRT), a plasma display, a light emitting diode (LED) display, and any combinations thereof. In addition to a display device, the computer device or system may include one or more other peripheral output devices including, but not limited to, an audio speaker, a printer, and any combinations thereof. Such peripheral output devices may be connected to a bus via a peripheral interface. Examples of a peripheral interface may include, but are not limited to, a serial port, a USB connection, a FIREWIRE connection, a parallel connection, and any combinations thereof.

While considerable emphasis has been placed herein on the specific elements of the preferred embodiment, it will be appreciated that many alterations can be made and that many modifications can be made in preferred embodiment without departing from the principles of the invention. These and other changes in the preferred embodiments of the invention will be apparent to those skilled in the art from the disclosure herein, whereby it is to be distinctly understood that the foregoing descriptive matter is to be interpreted merely as illustrative of the invention and not as a limitation.

What is claimed is:

1. A system for modification of future recipients in an electronic signature workflow, comprising:
an electronic document having signature tags for signing;
a pre-defined workflow for execution of a signing task for the electronic document comprising a sender and a plurality of recipients including a current recipient and at least one future recipient;
a sender communication device;
a recipient communication device corresponding to each recipient;
a processing unit operably associated with the sender communication device and the recipient communication device;
a sender communication interface;
a recipient communication interface corresponding to each recipient;
a set of computer readable instructions provided by the sender and executable by the processing unit;
a set of computer readable instructions provided by the recipient and executable by the processing unit; and
a computer readable storage medium capable of storing the set of instructions and provided by the sender and the recipient respectively;
wherein the system facilitates the modification of at least one future recipient in the workflow to a new recipient, by the sender of the document once the document has been sent by the sender for signing;
wherein, in an event wherein the modification of the future recipient is made by the sender, the system is adapted to:
send the document to the new recipient for signing;
alert the new recipient about discrepancy in names of recipient signature tags on the document;
present the new recipient with all the signature places having signature tags which need to be rectified;
allow the new recipient to update the name of the earlier recipient to his or her name, in the signature tags; and
rectify the recipient name and synchronize the modification in the entire document, wherever applicable.

2. The system as claimed in claim 1, wherein the system facilitates the modification of at least one future recipient in the workflow by any recipient of the document once the document has been sent by the sender for signing.

3. The system as claimed in claim 2, wherein in an event wherein the modification of the future recipient is made by any recipient, the system is adapted to send the future recipient modification request to the sender of the document for his or her approval and upon approval of the request by the sender execute the following:
send the document to the new recipient for signing; and
alert the new recipient about discrepancy in names of recipient signature tags on the document;
present the new recipient with all the signature tags which need to be rectified;
allow the new recipient to update the name of the earlier recipient to his or her name, in the signature tags; and
rectify the recipient's name and synchronize the modification in the entire document, wherever applicable.

4. The system as claimed in claim 1, wherein the sender communication device and the recipient both are devices including but not limiting to a desktop computer, a laptop and a handheld communication device.

5. The system as claimed in claim 1, wherein the document is transmitted in the workflow in a pre-defined sequence of plurality of recipients specified at the time of sending of the document by the sender.

6. The system as claimed in claim 1, wherein the modification of a future recipient includes but is not limited to actions such addition of a recipient, deletion of a recipient, replacement of a recipient and provision of an alternate recipient.

7. A method for modification of future recipients in an electronic signature workflow comprising an electronic document having signature tags for signing, a pre-defined workflow for execution of signing task for the electronic document comprising a sender and a plurality of recipients including a current recipient and at least one future recipient, a sender communication device, a recipient communication device corresponding to each recipient, a processing unit operably associated with the sender communication device and the recipient communication device each, a sender communication interface, a recipient communication interface corresponding to each recipient, a set of computer readable instructions provided by the sender and executable by the processing unit, a set of computer readable instructions provided by the recipient and executable by the processing unit, and a computer readable storage medium capable of storing the set of instructions and provided by the sender and the recipient respectively, comprising the steps of:
uploading an electronic document to be signed by the sender by means of his or her communication device;
defining a signing workflow and its sequence by the sender by providing a computer readable set of instructions, by means of the sender communication interface;
sending the electronic document by providing a computer readable set of instructions by the sender, by means of the sender communication interface;
receiving the electronic document on the recipient communication device and displaying it to the recipient by means of the recipient communication interface;
electronic signing of the document by the recipients involved in the workflow until the document is signed by all the recipients;
wherein in an event wherein the document is pending with one of the recipients, the modification of one or more future recipients in the workflow by the sender to an updated recipient is allowed;
sending the document to the new recipient for signing, when a future recipient modification request is made by the sender;
alerting the new recipient regarding the discrepancy in the names of the signature tags consisting the name of the earlier recipient;
allowing the new recipient to provide the updated name in the signature tags with discrepancy, by means of the recipient communication interface;
rectifying the name and updating all such signature tags in the entire document, wherever applicable, thereby synchronizing the signature tags with the future recipient modification request made; and
transmitting the document in the defined sequence of the workflow until the document is signed by all the pre-defined or updated recipients.

8. The method as claimed in claim 7, wherein the method facilitates the modification of at least one future recipient in the workflow by any recipient of the document once the document has been sent by the sender for signing.

9. The method as claimed in claim 7, wherein in an event wherein the modification of the future recipient is made by any recipient, the method is adapted to send the future recipient modification request to the sender of the document for his or her approval and upon approval of the request by the sender execute the following:
sending the document to the new recipient for signing;
alerting the new recipient about discrepancy in names of recipient signature tags on the document;
presenting the new recipient with all the signature tags which need to be rectified;
allowing the new recipient to update the name of the earlier recipient to his or her name, in the signature tags; and
rectifying the recipient's name and synchronize the modification in the entire document, wherever applicable.

10. The method as claimed in claim 9, wherein the method comprises the steps of:
uploading an electronic document to be signed by the sender by means of his or her communication device;
defining a signing workflow and its sequence by the sender by providing a computer readable set of instructions, by means of the sender communication interface;
sending the electronic document by providing a computer readable set of instructions by the sender, by means of the sender communication interface;
receiving the electronic document on the recipient communication device and displaying it to the recipient by means of the recipient communication interface;
electronically signing of the document by the recipients involved in the workflow until the document is signed by all the recipients;
such that in an event wherein the document is pending with one of the recipients the modification of one or more future recipients in the workflow by any of the recipients to an updated recipient is allowed;
sending an approval request to the sender in an event wherein the modification request is made by any recipient in the workflow;
executing the following steps in an event wherein the sender approves the future recipient modification request;
i. sending the document to the new recipient for signing;
ii. alerting the new recipient regarding the discrepancy in the names of the signature tags consisting the name of the earlier recipient;
iii. allowing the new recipient to provide the updated name in the signature tags with discrepancy, by means of the recipient communication interface; and
iv. rectifying the name and updating all such signature tags in the entire document, wherever applicable, thereby synchronizing the signature tags with the future recipient modification request made;
skipping of steps i to iv in an event wherein the sender denies the future recipient modification request made by a recipient in the workflow; and
transmitting of the document in the defined sequence of the workflow until the document is signed by all the pre-defined or updated recipients.

11. The method as claimed in claim 7, wherein the sender communication device and the recipient both are devices including but not limiting to a desktop computer, a laptop and a handheld communication device.

12. The method as claimed in claim 7, wherein the document is transmitted in the workflow in a pre-defined sequence of plurality of recipients specified at the time of sending of the document by the sender.

13. The method as claimed in claim 7, wherein the modification of a future recipient includes but is not limited to actions such addition of a recipient, deletion of a recipient, replacement of a recipient and provision of an alternate recipient.
